(19) United States
(12) Patent Application Publication
(10) Pub. No.: US 2006/0098225 A1
(43) Pub. Date: May 11, 2006

(54) Job control method in image forming apparatus, image forming apparatus and image forming program

(76) Inventor: Masahiro Machida, Ebina-shi (JP)

Correspondence Address: GAUTHIER & CONNORS, LLP, 225 FRANKLIN STREET, BOSTON, MA, 02110, US

(21) Appl. No.: 11/079,957

(22) Filed: Mar. 15, 2005

(30) Foreign Application Priority Data
Nov. 5, 2004 (JP) 2004-322753

(51) Int. Cl. G06F 3/12

(52) U.S. Cl. 358/1.15; 709/203

(57) ABSTRACT

An image forming apparatus provides a job memory function in which, when a job registration button is pressed by a user, a job registration processing section determines the type of operation input by the user. If the operation is one involving connecting to a network, then the job registration processing is forced into termination or, alternatively, the job registration processing section displays a confirmation message on an operation panel prompting the user to confirm whether or not to register the job. Still alternatively, the access destination may be checked against permission information, and if access is permitted to the access destination, the operation involving network connection is registered with the job. When a job reproduction button is pressed, a job execution control section starts reproduction of a job selected by the user. However, if an operation which causes network connection is detected, the job execution control section forcibly terminates reproduction of the job. Alternatively, the job execution control section displays a confirmation message on the operation panel to confirm whether or not to reproduce the job, or the access destination is checked against the permission information, and the operation is performed when it is determined that that access to the destination is permitted.

### BACKGROUND OF THE INVENTION

1. Field of the Invention

The present invention relates to an image forming apparatus having a job memory function, and more particularly to restriction on an operation which causes network connection.

2. Description of Related Art

Recently, an increasing number of functions have been added to image forming apparatuses, resulting, for example, in relatively complex devices having a copy function and a scanner function. Some devices are even provided with a function of exchanging data with an external apparatus via a network, such as a Scan-To-Mail function. Some devices also have a job memory function for improving convenience to a user.

Here, a job memory function is a function for enabling registration of a sequence of operations which can be repeated. The job memory function mainly includes a job registration function of generating a job by recording a sequence of operations input by a user through an operation panel of an image forming apparatus and registering the generated job in storage means commonly known as a “job memory”, and a job reproduction function of selecting a job registered in the job memory and performing it. For example, if a procedure for reading a double-sided manuscript and then sending it to a specified mail address is registered with the memory as a job, once this job has been registered, the entire procedure can be executed simply by selecting that job. It is also possible to input and specify a parameter value such as a destination address and a document to be sent, as necessary.

Thus, the job memory function can conveniently eliminate the necessity of repeatedly inputting a similar operation.

However, if jobs involving the sending of data to an external apparatus are registered or reproduced unconditionally, it is disadvantageously possible that an important document or confidential information may be sent to an external third party, or that unexpected communication costs may occur due to human error or unauthorized use.

### SUMMARY OF THE INVENTION

The present invention has been made in view of the above circumstances and provides a job control method which provides an image forming apparatus with an improved job memory function, and an improved image forming apparatus.

According to an aspect of the present invention, a job control method being performed by a computer which is mounted on an image forming apparatus connected to a network and which has a job registration function of registering with a job memory a job generated by recording a sequence of operations user-input from an operation panel of the image forming apparatus, the method comprising: determining whether an operation which involves network access has been input during execution of the job registration function; and aborting job generation when it is determined that an operation which causes network access has been input.

According to another aspect, an image forming apparatus comprises an operation panel; a network communication unit; a job memory; and a job registration processor that executes a job registration function of generating a job by determining the nature of an operation input from the operation panel and by recording a sequence of operations user-input from the operation panel, and then registering the job with the job memory, wherein the job registration processor inhibits input of an operation which causes network access when the job registration function is executed.

According to another aspect, the image forming apparatus comprises a permission information memory that stores identification information about external apparatuses for which network access is permitted or inhibited in execution of a job, wherein if it is determined that access to an external apparatus specified as an access destination by a user through the operation panel is permitted based on information stored in the permission information memory before inhibiting input of an operation which causes network access, the job registration processor releases inhibition of input.

According to another configuration, an image forming program according to the present invention causes a computer which is mounted on an image forming apparatus connected to a network and which has a job registration function of registering with a job memory a job generated by recording a sequence of operations user-input from an operation panel of the image forming apparatus to function as determining the nature of an operation input from the operation panel; executing a job registration function of generating a job by recording a sequence of operations user-input from the operation panel, and then registering the job with the job memory; and inhibiting input of an operation which causes network access when the job registration function is executed.

A job control method according to the present invention may be performed by a computer which is mounted on an image forming apparatus connected to a network and which has a job reproduction function of displaying jobs registered with a job memory on an operation panel of the image forming apparatus and reproducing a job selected by a user from among the displayed jobs. Such a method may comprise determining the nature of an operation included in the job while executing the job reproduction function; and aborting job reproduction when an operation which causes network access is detected.

An image forming apparatus according to the present invention may comprise an operation panel; a network communication unit;

a job memory that stores a job for reproducing a sequence of operations input from the operation panel; and a job execution controller that reads a job selected by a user from the job memory, determines the nature of a processing to be executed and executes the read job, wherein the job execution controller aborts job reproduction when an operation which causes network access is detected.

An image forming apparatus according to the present invention may comprise a permission information memory that stores identification information concerning external apparatuses to which network access is permitted or inhibited during execution of a job, wherein if it is determined based on the information stored on the permission information memory that access to a particular network access destination is permitted, the job execution controller releases abort of reproduction before aborting job reproduction.

An image forming program according to the present invention may cause a computer which is mounted on an image forming apparatus connected to a network and which has a job reproduction function of displaying jobs registered with a job memory on an operation panel of the image forming apparatus and reproducing a job selected from among the jobs by a user, to function as determining the nature of an operation included in the job while executing the job reproduction function; and aborting job reproduction when an operation which causes network access is detected.

### BRIEF DESCRIPTION OF THE DRAWINGS

Embodiments of the present invention will be described in detail based on the following figures, wherein:

FIG. 1 is a block diagram of an image forming system including an embodiment of an image forming apparatus according to the present invention;

FIG. 2 is a flowchart showing a job registration processing in an Embodiment 1 of the present invention;

FIG. 3 is a flowchart showing a job registration processing in an Embodiment 2 of the present invention;

FIG. 4 is a block diagram of another image forming system according to the present invention;

FIG. 5 is a flowchart showing a job registration processing in an Embodiment 3 of the present invention;

FIG. 6 is a flowchart showing a job reproduction processing in an Embodiment 4 of the present invention;

FIG. 7 is a flowchart showing a job reproduction processing in an Embodiment 5 of the present invention; and

FIG. 8 is a flowchart showing a job reproduction processing in an Embodiment 6 of the present invention.

### DESCRIPTION OF THE PREFERRED EMBODIMENTS

Embodiments of the present invention will be now described below based on the drawings.

### Embodiment 1

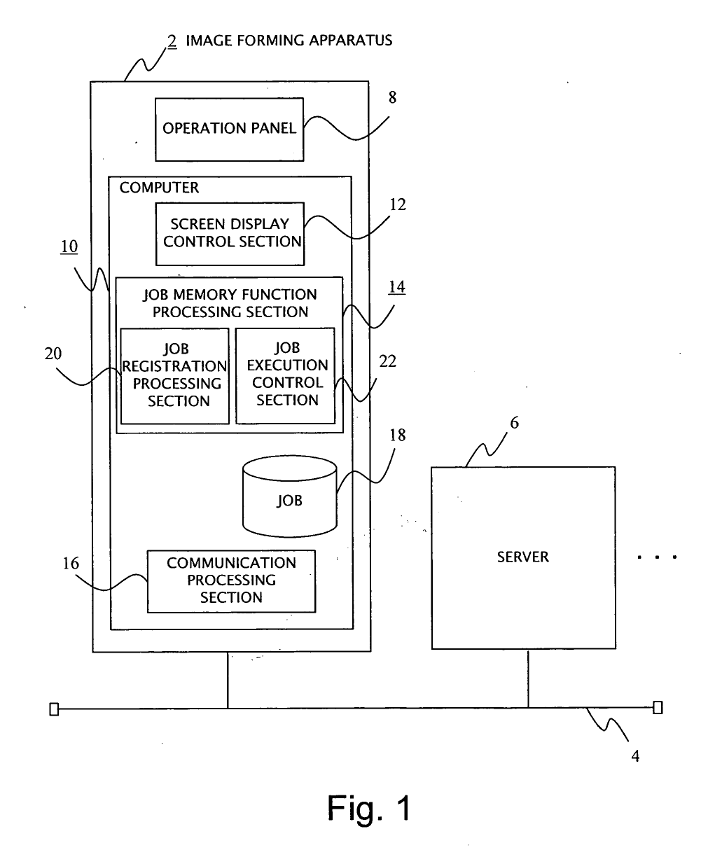

FIG. 1 is a block diagram of an image forming system including an embodiment of an image forming apparatus according to the present invention. In FIG. 1, there are shown an image forming apparatus 2 and a server 6 which performs data communication with the image forming apparatus 2 via a network 4. Although multiple servers 6 can be connected to the network 4, the same configuration can also be applied to multiple servers, and only one server 6 is shown in FIG. 1 for convenience of explanation only. The network 4 may be, for example, an intranet or the Internet.

The image forming apparatus 2 in this embodiment is assumed to be a complex device to which additional devices such as a finisher and a document feeder are connectably attached, and which is provided with a copy function, a fax function, a scanner function, and the like as basic functions. A user inputs and specifies required parameters and the like from a setting screen displayed on an operation panel 8 of the image forming apparatus 2 to use the various functions.

A computer 10 has a screen display control section 12, a job memory function processing section 14, a communication processing section 16 and a job storage section (a job memory) 18. The screen display control section 12 controls display of various setting screens on the operation panel 8 of the image forming apparatus 2. For example, for a Scan-To-Mail function, the screen display control section 12 causes the user to input and set a resolution and a destination of an e-mail message by switching setting screens as required. The job memory function processing section 14 controls execution of the job memory function in conjunction with the screen display control section 12. A job registration processing section 20 included in the job memory function processing section 14 executes a job registration function of generating a job by determining the content and the kind of an operation input from the operation panel 8 and by recording a sequence of operations input by a user through the operation panel 8, and then registering a job with the job storage section 18. A job execution control section 22 reads a job selected by the user from the job memory 18 and executes the job reproduction function. The communication processing section 16 performs a data communication processing with the server 6, as one example of an external apparatus, via the network 4. The processing functions of the screen display control section 12, the job memory function processing section 14, and the communication processing section 16 are realized by an operation performed by the computer 10 and software for realizing the processing functions, acting cooperatively.

As described above, the job memory function is a function for enabling registration of a sequence of operations as a job for reuse to the job storage section 18. For example, when a job of sending data to an external apparatus such as the server 6 (hereinafter referred to as “a data sending job”) is registered with the job storage section 18, if the data sending job is registered or can be reproduced unconditionally, unexpected communication costs may occur when an incorrectly selected job is executed. Furthermore, if the job is selected and executed by a third party without authorization, confidential data and the like may be leaked.

Accordingly, in this embodiment, by including each characteristic determination processing in execution of the job registration function, and in execution of the job reproduction function so that the above-mentioned problems can be prevented from being caused. The processing performed when the job registration function is executed and the processing performed when the job reproduction function is executed will be described in Embodiments 1 to 3 and Embodiments 4 to 6, respectively.

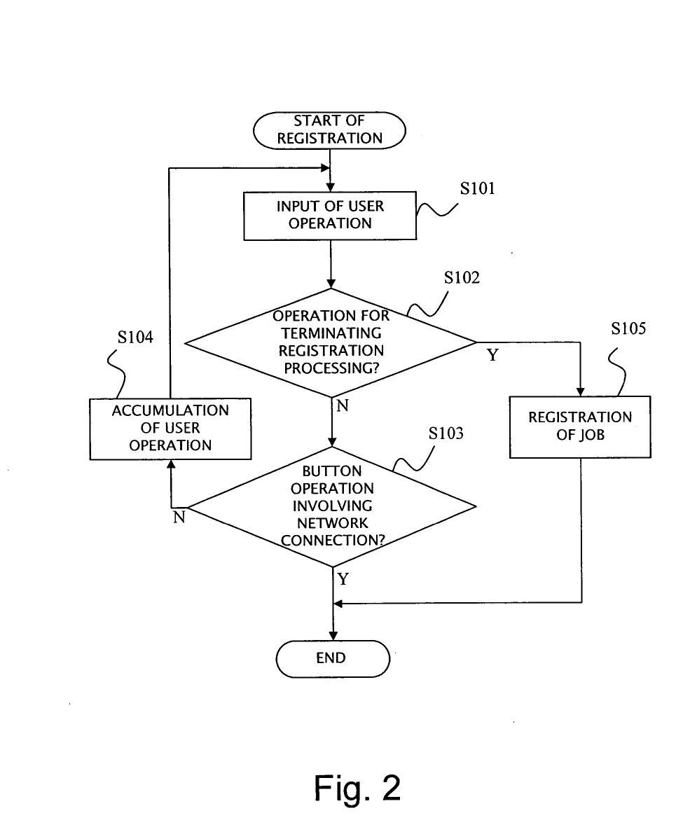

The operation in this embodiment will be now described with the use of the flowchart shown in FIG. 2.

The job registration processing is started when a user selects a job registration button on a screen displayed on the operation panel 8. After the registration button is pressed, when the user performs a desired button operation from the setting screen, the job registration processing section 20 accepts the input operation (step 101) and determines the type of operation. As a result, if it is recognized that an input operation is one that does not cause network access, such as, for example, an operation specifying a number of copies to be made, the job registration processing section 20 temporarily stores the user operation internally (steps 103 and 104). On the other hand, if it is recognized that the selected operation is one involving network operations, such as the sending of an e-mail message, the job registration processing section 20 forcibly terminates the job registration (step 103), and no job is generated. If the user presses a job registration processing completion button, then a job is generated in which the sequence of user operations stored at step 104 in the order input by the user, and the job is then registered with the job storage section 18 (step 105).

According to this embodiment, although the job registration processing is performed as described above, because step 103 is provided, job registration is terminated when an operation involving connection to the network 4 is input by a user. That is, in this embodiment, registration of any job including an operation requiring network access is prevented, and thereby it is possible to prevent problems such as accidentally-generated communication costs or malicious leaking of information.

In the example described above, it is determined, by analyzing the content of user input, whether an input operation involves accessing a network, and, if so, input of the selected operation is inhibited. In addition to such a configuration, it is also possible to first determine, when a setting screen is displayed on the operation panel 8, for example, whether or not any button related to accessing a network is included in the setting screen, and, if there is such a button, to inhibit input by disabling the button, and, for example, not displaying the button or displaying a ghosted button to indicate that the associated function is disabled.

### Embodiment 2

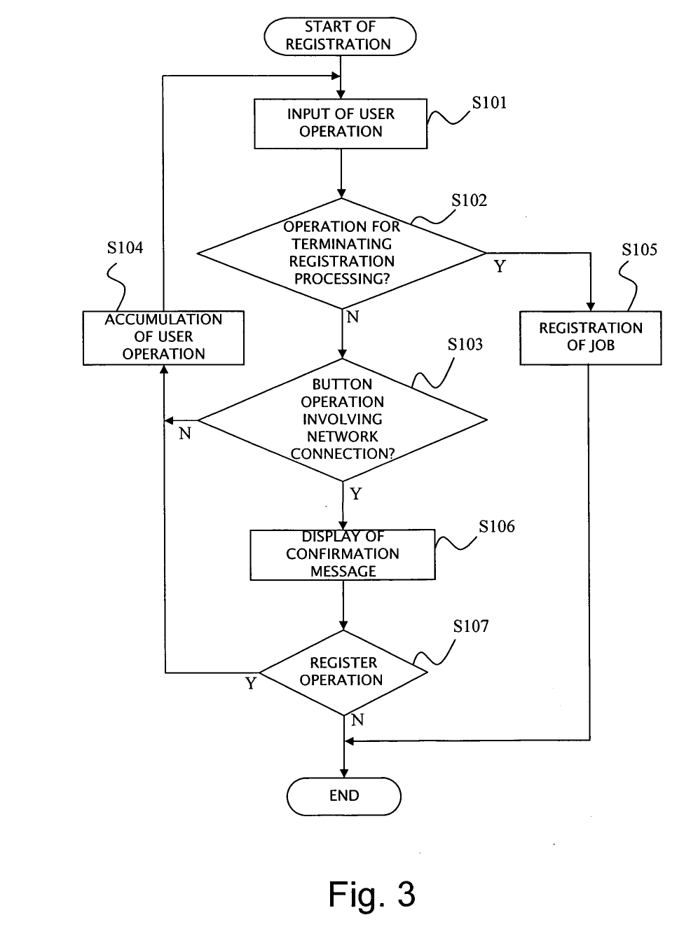

The operation in this embodiment will be now described with the use of the flowchart shown in FIG. 3. In flowcharts to be used in description of respective embodiments provided hereinafter, similar processing steps are denoted by the same step number, and repeated explanation thereof will be omitted as appropriate. The configuration of an image forming apparatus in this embodiment is the same as that of Embodiment 1, and the only difference is the content of the processing performed by the job registration processing section 20, as described below.

When a user uses a setting screen to input a desired operation after pressing a job registration button, the job registration processing section 20 accepts the input operation (step 101) and determines the category or type of the input operation. As a result, if it is recognized that the input operation is one that does not cause network access, then the job registration processing section 20 temporarily stores the user operation (steps 103 and 104). On the other hand, if it is recognized that the button operation is one that causes network access, then the job registration processing section 20 in this embodiment displays a confirmation screen on the operation panel 8. This confirmation screen includes a message informing the user to the effect that an operation involving network connection has been selected along with a message prompting the user to select either that the operation be registered as part of the job, in which case the job registration is continued, or that the job registration be terminated. The user inputs their choice using buttons displayed on the screen.

If the user selects continuation of the job registration, then the job registration processing section 20 temporarily stores the operation involving network connection (steps 107 and 104). On the other hand, if the user selects termination of the job registration, then the job registration processing section 20 terminates the job registration (step 103), and no job is generated.

If the user presses the job registration processing completion button, then a job is generated in which the sequence of user operations accumulated at step 104 in the order input, and this job is registered with the job storage section 18 (step 105).

In Embodiment 1, if it is recognized that an input operation involves accessing a network, the job registration processing is forced into termination to prevent such a job from being generated. In Embodiment 2, however, in consideration of user convenience, such a job may be registered after confirmation by the user.

### Embodiment 3

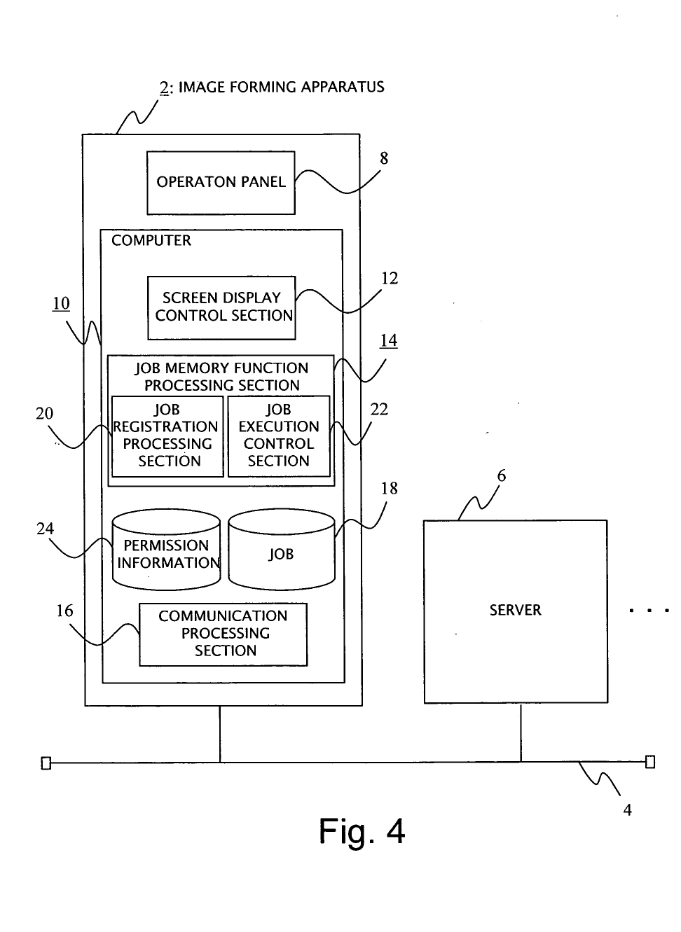

FIG. 4 is a block diagram of an image forming system according to the present embodiment. FIG. 4 shows an image forming apparatus 2 similar to that shown in FIG. 1, but to which is additionally provided a permission information storage section 24. As the configuration is otherwise the same as that shown in FIG. 1, explanation of other sections will not be repeated here. The permission information storage section 24 stores identification information as to which external apparatuses network access is permitted or inhibited in execution of a job. In this embodiment, the IP address of a server 6 to which network access is permitted by an administrator or the e-mail address of a user to which mail be sent is set and registered in advance as permission information.

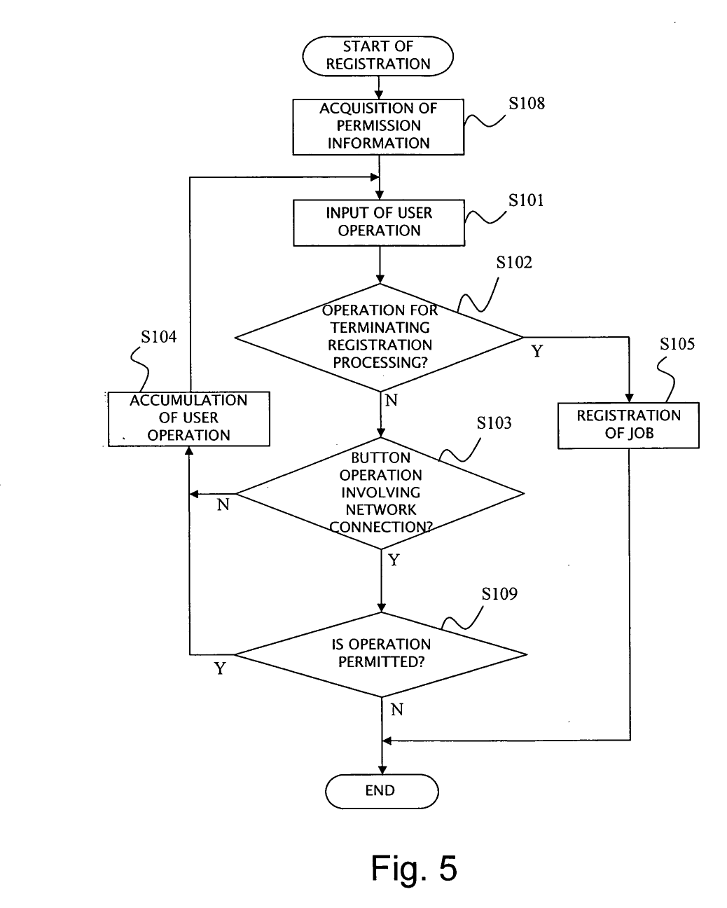

The operation in this embodiment will be now described using the flowchart shown in FIG. 5.

When a user presses a job registration button displayed on the operation panel 8, the job registration processing section 20 in this embodiment reads permission information registered with the permission information storage section 24, and retains this information internally (step 108). Then, when the user performs a desired button operation using a setting screen, the job registration processing section 20 accepts the input operation (step 101) and determines the type of operation. As a result, when it is recognized that an input operation is one that does not cause the apparatus to access a network, the job registration processing section 20 temporarily stores the user operation (steps 103 and 104). On the other hand, if it is recognized that the input operation involves accessing a network, the job registration processing section 20 in this embodiment first obtains a network access destination input by the user and then checks the access destination against the permission information read from the permission information storage section 24. If the access destination input by the user is included in the permission information, then the job registration processing section 20 permits the operation involving network connection and the input specifying the access destination and temporarily stores this information (steps 109 and 104). On the other hand, if the access destination input by the user is not included in the permission information, then the job registration processing section 20 terminates the job registration (step 109), and no job is generated.

If the user presses the job registration processing completion button, a job is generated in which the sequence of user operations accumulated at step 104 in the order input, and this sequence is registered with the job storage section 18 (step 105).

In this embodiment, operations which involve network access are not necessarily eliminated, but, such as in the case of an operation to access a destination for which access is permitted by an administrator, such as a secure external apparatus or verified user, is allowed. Thereby, user convenience can be further enhanced.

### Embodiment 4

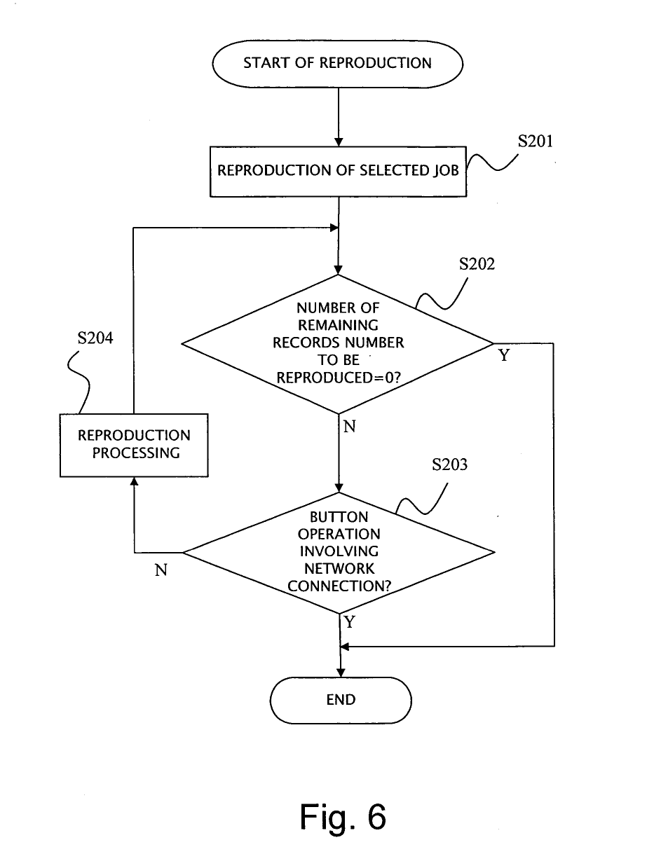

While Embodiments 1 to 3 relate to processes performed when the job registration function is executed, the embodiments described hereinafter are processes performed when the job reproduction function is executed. The operation in this embodiment, Embodiment 4, will be now described with the use of a flowchart shown in FIG. 6. The configuration of an image forming apparatus in this embodiment is the same as that of Embodiment 1.

The job reproduction processing is started by a user pressing a job reproduction button on a screen displayed on the operation panel 8. When the reproduction button is pressed, the job execution control section 22 displays on the operation panel 8 a list of the jobs registered with the job storage section 18. When the user selects a desired job from among the jobs displayed as a list, the job execution control section 22 begins to reproduce the selected job according to the sequence of operations described in the job (step 201).

The job execution control section 22 executes operations in order while determining the nature or type of each of the operations. If an operation does not involve accessing a network, then the job execution control section 22 performs a reproduction processing based on the operation (steps 203 and 204). Such processing is repeatedly performed until all job operations have been executed, at which point the job execution control section 22 normally terminates the job (step 202). On the other hand, if an operation which causes network access is detected, then the job execution control section 22 immediately terminates reproduction of the job (step 203). That is, the sequence of operations described in the job is forced into termination as it is being performed. For example, if a sequence of operations for utilizing a Scan-To-Mail function is described in the job, scanning of a document is performed, but the sending of electronic mail is not performed.

According to this embodiment, the step 203 is provided so that reproduction of a job is terminated when an operation which causes network access is detected. That is, in this embodiment, reproduction of an operation which causes network access is always prevented, which makes it possible to prevent problems such as unexpected communication costs or intentional leaking of confidential information.

### Embodiment 5

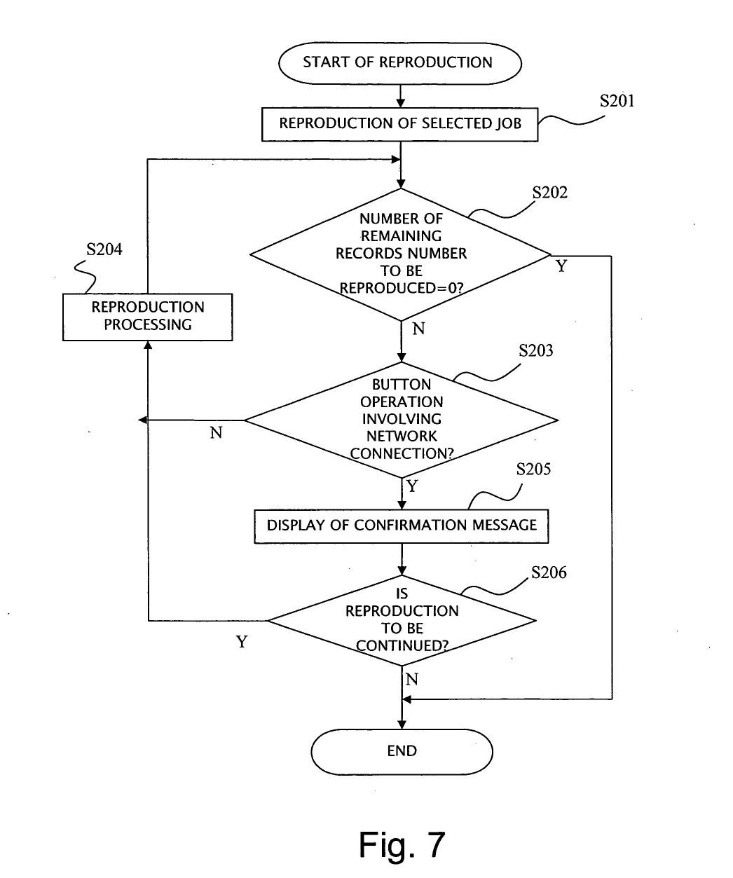

The operation in this embodiment will be now described with the use of the flowchart shown in FIG. 7. The configuration of the image forming apparatus in this embodiment is the same as that in Embodiment 1, with the exception of the content of the processing performed by the job execution control section 22, as described below.

In the present embodiment, when a user selects a job by pressing a job reproduction button, the job execution control section 22 starts reproduction of the selected job (step 201). For operations which do not involve accessing a network, reproduction processing is performed until all operations associated with the job have been executed (steps 203, 204 and 202). On the other hand, if an operation which involves the accessing of a network is detected, the job execution control section 22 displays a confirmation screen on the operation panel 8 (step 205). This confirmation screen includes a message notifying the user that an operation involving network connection is about to be performed, information of the specific content of the operation such as content of access and an access destination, a message prompting of the user to select whether to continue or terminate the job, and selection buttons.

If the user selects continuation of reproduction of the job, then the job execution control section 22 performs the processing associated with the operation concerned (steps 206 and 204). On the other hand, if the user selects termination, then the job execution control section 22 terminates reproduction of the job (step 206).

According to this embodiment, a user is notified in advance that a job involves accessing an external apparatus through a network, thereby enabling the prevention of network access caused by incorrect selection of a job, although unauthorized use cannot be prevented by this step alone.

### Embodiment 6

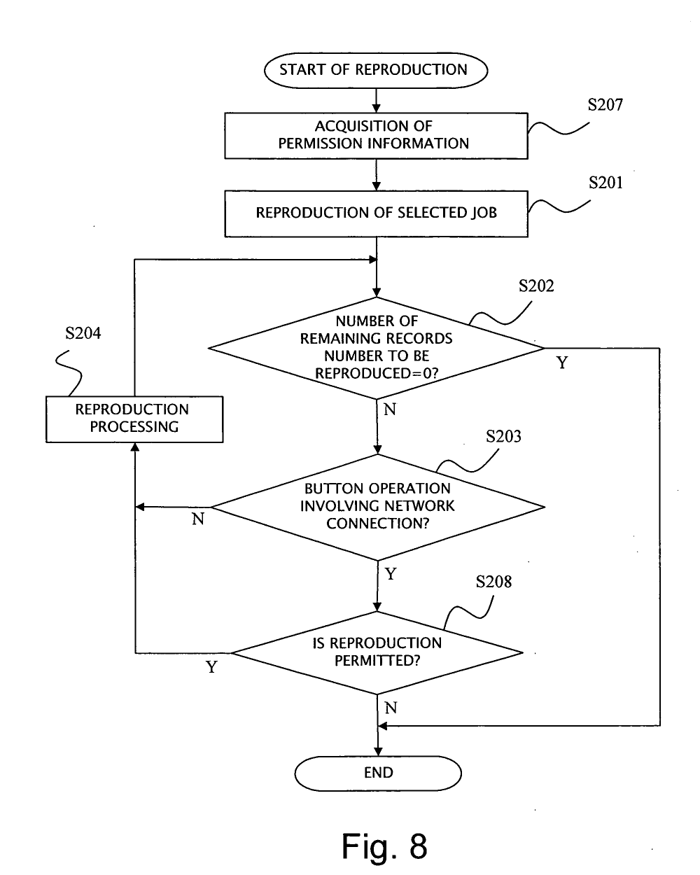

The operation in this embodiment will be now described with the use of a flowchart shown in FIG. 8. The configuration of an image forming apparatus in this embodiment is the same as that of Embodiment 3.

When a user presses a job reproduction button, the job execution control section 22 reads and retains permission information registered with the permission information storage section 24 (step 207). Then, when the user selects a job from the operation panel 8, the job execution control section 22 starts reproduction of the selected job (step 201). For operations which do not involve accessing a network, the reproduction processing is performed until all operations associated the job have been executed (steps 203, 204 and 202). If, on the other hand, an operation involving accessing a network is detected, the job execution control section 22 first reads a network access destination associated with the operation and checks the read access destination against the permission information read from the permission information storage section 24. If the access destination is included in the permission information, then the job execution control section 22 performs the operation requiring the accessing of a network (steps 208 and 204). On the other hand, if the access destination is not included in the permission information, then the job execution control section 22 terminates reproduction of the job (step 208).

In this embodiment, operations which involve network access are not necessarily eliminated, but, in the case of an operation involving access to destination for which access is permitted by an administrator such as a secure external apparatus or verified recipient, for example, reproduction of a job is allowed. Thereby, user convenience can be enhanced.

According to each of the above embodiments, for both job registration and job reproduction, when an operation which causes network access is detected, the operation is not accepted or reproduced unconditionally, but some type of restriction is imposed thereon. Inclusion of such a feature makes it possible to prevent unexpected communication costs or unintended or undesirable leaking of information.

Although the features of the present invention have been separately described in each of the embodiments, the embodiments can be implemented in any appropriate combination, such as, for example, combinations of Embodiments 2 and 3, Embodiments 5 and 6, or Embodiments 2, 3, 5, and 6.

The entire disclosure of Japanese Patent Application No. 2004-322753 including the specification, claims, drawings and abstract is incorporated herein by reference.

What is claimed is:

1. A job control method being performed by a computer which is mounted on an image forming apparatus connected to a network and which has a job registration function of registering with a job memory a job generated by recording a sequence of operations user-input from an operation panel of the image forming apparatus,
the method comprising:
determining whether an operation which involves network access has been input during execution of the job registration function; and
aborting job generation when it is determined that an operation which causes network access has been input.

2. The job control method in an image forming apparatus, according to claim 1, wherein
before aborting job generation, displaying on the operation panel a message for confirming whether job generation should be continued or terminated, and then, if a continuation instruction is input by a user, accepting input of the operation and continuing job generation.

3. The job control method in an image forming apparatus, according to claim 1, wherein
if access to an external apparatus specified as an access destination by a user through the operation panel before aborting job generation is permitted by permission information, continuing job generation.

4. An image forming apparatus comprising:
an operation panel;
a network communication unit;
a job memory; and
a job registration processor that executes a job registration function of generating a job by determining the nature of an operation input from the operation panel and by recording a sequence of operations user-input from the operation panel, and then registering the job with the job memory, wherein
the job registration processor inhibits input of an operation which causes network access when the job registration function is executed.

5. The image forming apparatus according to claim 4, wherein
the job registration processor disables selection of a button for an operation which causes network access among buttons included in an operation screen displayed on the operation panel.

6. The image forming apparatus according to claim 4, wherein
the job registration processor displays on the operation panel a message for confirming whether job generation should be continued or terminated before inhibiting input of an operation which causes network access, and then, if continuation is instructed by a user by input according to the display, releases inhibition of input of the operation.

7. The image forming apparatus according to claim 4, further comprising:
a permission information memory that stores identification information about external apparatuses for which network access is permitted or inhibited in execution of a job, wherein
if it is determined that access to an external apparatus specified as an access destination by a user through the operation panel is permitted based on information stored in the permission information memory before inhibiting input of an operation which causes network access, the job registration processor releases inhibition of input.

8. An image forming program causing a computer which is mounted on an image forming apparatus connected to a network and which has a job registration function of registering with a job memory a job generated by recording a sequence of operations user-input from an operation panel of the image forming apparatus to function as:
determining the nature of an operation input from the operation panel;
executing a job registration function of generating a job by recording a sequence of operations user-input from the operation panel, and then registering the job with the job memory; and
inhibiting input of an operation which causes network access when the job registration function is executed.

9. A job control method being performed by a computer which is mounted on an image forming apparatus connected to a network and which has a job reproduction function of displaying jobs registered with a job memory on an operation panel of the image forming apparatus and reproducing a job selected by a user from among the displayed jobs,
the method comprising:
determining the nature of an operation included in the job while executing the job reproduction function; and
aborting job reproduction when an operation which causes network access is detected.

10. The job control method in an image forming apparatus, according to claim 9, wherein
before aborting job reproduction, displaying on the operation panel a message for confirming whether job reproduction should be continued or terminated, and then, if continuation is instructed by a user by input, releasing abort of job reproduction.

11. The job control method in an image forming apparatus, according to claim 9, wherein
if access to an external apparatus specified as an access destination by a user through the operation panel before aborting job reproduction is permitted by permission information, releasing abort of job reproduction.

12. An image forming apparatus comprising:
an operation panel;
a network communication unit;
a job memory that stores a job for reproducing a sequence of operations input from the operation panel; and
a job execution controller that reads a job selected by a user from the job memory, determines the nature of a processing to be executed and executes the read job, wherein
the job execution controller aborts job reproduction when an operation which causes network access is detected.

13. The image forming apparatus according to claim 12, wherein
the job execution controller displays a message for confirming whether job reproduction should be continued or terminated on the operation panel before aborting job reproduction, and then, if continuation is instructed by a user by input, releases termination of job reproduction.

14. The image forming apparatus according to claim 12, further comprising:
a permission information memory that stores identification information concerning external apparatuses to which network access is permitted or inhibited during execution of a job, wherein
if it is determined based on the information stored on the permission information memory that access to a particular network access destination is permitted, the job execution controller releases abort of reproduction before aborting job reproduction.

15. An image forming program, causing a computer which is mounted on an image forming apparatus connected to a network and which has a job reproduction function of displaying jobs registered with a job memory on an operation panel of the image forming apparatus and reproducing a job selected from among the jobs by a user, to function as:
determining the nature of an operation included in the job while executing the job reproduction function; and
aborting job reproduction when an operation which causes network access is detected.
